(19) United States
(12) Patent Application Publication
(10) Pub. No.: US 2025/0189765 A1
(43) Pub. Date: Jun. 12, 2025

(54) IMAGING LENS SYSTEM

(71) Applicants: SAMSUNG ELECTRO-MECHANICS CO., LTD., Suwon-si (KR); KUMOH NATIONAL INSTITUTE OF TECHNOLOGY INDUSTRY-ACADEMIC COOPERATION FOUNDATION, Gumi-si (KR)

(72) Inventors: Yong Joo JO, Suwon-si (KR); Jae Myung RYU, Gumi-si (KR); Phil Ho JUNG, Suwon-si (KR); Tae Yeon LIM, Suwon-si (KR)

(73) Assignees: SAMSUNG ELECTRO-MECHANICS CO., LTD., Suwon-si (KR); KUMOH NATIONAL INSTITUTE OF TECHNOLOGY INDUSTRY-ACADEMIC COOPERATION FOUNDATION, Gumi-si (KR)

(21) Appl. No.: 18/908,366

(22) Filed: Oct. 7, 2024

(30) Foreign Application Priority Data
Dec. 6, 2023 (KR) 10-2023-0175849

(51) Int. Cl. G02B 13/00; G02B 9/64

(52) U.S. Cl. CPC G02B 13/0045; G02B 9/64

(57) ABSTRACT

An imaging lens system according to an embodiment of the present disclosure comprises a first lens group including one or more lenses, and a second lens group including one or more lenses and configured to be movable in an optical axis direction. The imaging lens system according to an embodiment of the present disclosure, the first lens group and the second lens group are sequentially arranged from an object side. The imaging lens system according to an embodiment of the present disclosure satisfies the condition 2.80≤fG1R/f≤4.0. F is a focal length of the imaging lens system, and fG1R is a focal length of a first rear lens disposed closest to the imaging plane in the first lens group.

### CROSS-REFERENCE TO RELATED APPLICATIONS

This application claims the benefit under 35 USC 119(a) of Korean Patent Application No. 10-2023-0175849, filed on Dec. 6, 2023, in the Korean Intellectual Property Office, the entire disclosure of which is incorporated herein by reference for all purposes.

### BACKGROUND

### 1. Field

The following description relates to an imaging lens system configured to enable thinning and minimize resolution degradation due to focus adjustment.

### 2. Description of the Background

Portable electronic devices may include a camera module for capturing a still image or recording a moving image. For example, a camera module can be mounted on a mobile phone, a laptop, a game console, or the like. Such portable electronic devices are generally manufactured in compact or small sizes to increase user convenience in carrying the devices. Therefore, the camera module mounted on the portable electronic device is configured to have a limited form of imaging lens system. For example, an imaging lens system including multiple lenses is difficult to mount on a portable electronic device because the distance from a foremost lens to an imaging plane is significant. Portable electronic devices with high-performance camera modules may desire an imaging lens system with a small change in resolution due to the movement of the focus lens or focus lens group.

The above information is presented as background information only to assist with an understanding of the present disclosure. No determination has been made, and no assertion is made, as to whether any of the above might be applicable as prior art with regard to the disclosure.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In one general aspect, an imaging lens system includes a first lens group including one or more lenses, and a second lens group, including one or more lenses, configured to be movable in an optical axis direction. The first lens group and the second lens group are arranged sequentially from an object side. The imaging lens system satisfies 2.80≤fG1R/f≤4.0, where f is a focal length of the imaging lens system, and fG1R is a focal length of a first rear lens disposed closest to an imaging plane in the first lens group.

The first rear lens may have a convex image-side surface.

The first lens group may have a total of two lenses.

The second lens group may have a total of four or five lenses.

A rearmost lens may be disposed closest to the imaging plane has positive refractive power.

A foremost lens may be disposed closest to an object has negative refractive power.

The imaging lens system may satisfy −1.50<fF/f<−1.20, where fF is a focal length of a foremost lens disposed closest to the object.

In another general aspect, an imaging lens system includes a first lens, an optical path converter, a second lens, a third lens, a fourth lens, a fifth lens, and a sixth lens, sequentially arranged from an object side. The imaging lens system satisfies 2.80≤f2/f≤4.0, and 1.40<D12/f<2.20, where f is a focal length of the imaging lens system, f2 is a focal length of the second lens, and D12 is a distance from an image-side surface of the first lens to an object-side surface of the second lens.

The first lens may have a convex object-side surface.

The second lens may have a convex object-side surface.

The third lens may have a convex object-side surface.

The fourth lens may have a convex object-side surface.

The fifth lens may have a concave object-side surface.

The sixth lens may have a convex object-side surface.

The imaging lens system may further include a seventh lens disposed on an image side of the sixth lens.

The seventh lens may have a convex object-side surface.

In another general aspect, an imaging lens system includes a first lens group including one or more lenses; and a second lens group, including one or more lenses, configured to be movable in an optical axis direction. The first lens group and the second lens group are arranged sequentially from an object side. The imaging lens system satisfies −1.5<f1/f<−1.20 and 2.80≤f2/f≤4.0, where f is a focal length of the imaging lens system, f1 is a focal length of a first lens of the imaging lens system, and f2 is a focal length of a second lens of the imaging lens system.

A first rear lens disposed closest to an imaging plane in the first lens group may have a convex image-side surface.

The first lens group may have a total of two lenses.

The second lens group may have a total of four or five lenses, and a rearmost lens disposed closest to an imaging plane in the first lens group may have positive refractive power.

Other features and aspects will be apparent from the following detailed description, the drawings, and the claims.

### BRIEF DESCRIPTION OF DRAWINGS

FIG. 1 is a configuration diagram of an imaging lens system according to an embodiment of the present disclosure.

FIG. 2 is an aberration curve of the imaging lens system illustrated in FIG. 1.

FIG. 3 is a configuration diagram of an imaging lens system according to an embodiment of the present disclosure.

FIG. 4 is an aberration curve of the imaging lens system illustrated in FIG. 3.

FIG. 5 is a configuration diagram of an imaging lens system according to an embodiment of the present disclosure.

FIG. 6 is an aberration curve of the imaging lens system illustrated in FIG. 5.

FIG. 7 is a configuration diagram of an imaging lens system according to an embodiment of the present disclosure.

FIG. 8 is an aberration curve of the imaging lens system illustrated in FIG. 7.

FIG. 9 is an enlarged view of the first lens and optical path converter according to the embodiments of the present disclosure.

FIG. 10 is an electronic device including an imaging lens system according to the embodiments of the present disclosure.

Throughout the drawings and the detailed description, unless otherwise described, the same reference numerals refer to the same elements. The drawings may not be to scale, and the relative size, proportions, and depiction of elements in the drawings may be exaggerated for clarity, illustration, and convenience.

### DETAILED DESCRIPTION

Hereinafter, while examples of the present disclosure will be described in detail with reference to the accompanying drawings, it is noted that examples are not limited to the same.

The following detailed description is provided to assist the reader in gaining a comprehensive understanding of the methods, apparatuses, and/or systems described herein.

However, various changes, modifications, and equivalents of the methods, apparatuses, and/or systems described herein will be apparent after an understanding of this disclosure. For example, the sequences of operations described herein are merely examples, and are not limited to those set forth herein, but may be changed as will be apparent after an understanding of this disclosure, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of this disclosure.

Throughout the specification, when an element, such as a layer, region, or substrate is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items; likewise, “at least one of” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms, such as “above,” “upper,” “below,” “lower,” and the like, may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above,” or “upper” relative to another element would then be “below,” or “lower” relative to the other element. Thus, the term “above” encompasses both the above and below orientations depending on the spatial orientation of the device. The device may also be oriented in other ways (rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

Herein, it is noted that use of the term “may” with respect to an example, for example, as to what an example may include or implement, means that at least one example exists in which such a feature is included or implemented while all examples are not limited thereto.

The features of the examples described herein may be combined in various ways as will be apparent after an understanding of this disclosure. Further, although the examples described herein have a variety of configurations, other configurations are possible as will be apparent after an understanding of this disclosure.

In this specification, a foremost lens or a first lens refers to a lens closest to an object (or subject), and the foremost lens refers to the lens closest to an imaging plane (or an image sensor). In the present specification, units of a radius of curvature, a thickness, TTL (a distance from an object-side surface of the first lens to the imaging plane), an IMGHT (or Y: a height of the imaging plane), and a focal length are indicated in millimeters (mm).

A thickness of a lens, a gap between lenses, and a TTL refers to a distance of a lens along an optical axis. Also, in the descriptions of a shape of a lens, a configuration in which one surface is convex indicates that a paraxial region of the surface may be convex, while a configuration in which one surface is concave indicates that a paraxial region of the surface may be concave. Thus, even when it is described that one surface of a lens is convex, an edge of the lens may be concave. Similarly, even when it is described that one surface of a lens is concave, an edge of the lens may be convex.

An imaging lens system, according to an embodiment of the present disclosure, may include two lens groups. For example, the imaging lens system according to an embodiment of the present disclosure may include a first lens group and a second lens group sequentially arranged from an object side. The imaging lens system according to an embodiment of the present disclosure may include a lens group movable in the optical axis direction. For example, in the imaging lens system according to an embodiment of the present disclosure, the second lens group may be configured to be movable in the optical axis direction. The imaging lens system according to an embodiment of the present disclosure may satisfy a unique conditional expression. For example, the imaging lens system according to an embodiment of the present disclosure may satisfy the conditional expressions 2.80≤fG1R/f≤4.0. In the conditional expression, fG1R is a focal length of a first rear lens disposed closest to an imaging plane in a first lens group, and f is a focal length of an imaging lens system.

The imaging lens system, according to an embodiment of the present disclosure, may include one or more of the features listed below as desired.

For example, the imaging lens system, according to an embodiment of the present disclosure, may include a lens having a convex image-side surface. For example, the imaging lens system, according to an embodiment of the present disclosure, the first rear lens may have a convex image-side surface.

As another example, in the imaging lens system, according to an embodiment of the present disclosure, the first lens group and the second lens group may respectively include two or more lenses. For example, the first lens group may have two lenses, and the second lens group may have four or five lenses. However, the number of lenses constituting the first lens group and the second lens group is not limited to the above-described form.

As another example, the imaging lens system, according to an embodiment of the present disclosure, may include a lens having positive refractive power. For example, in the imaging lens system according to an embodiment of the present disclosure, the rearmost lens disposed closest to the imaging plane may have positive refractive power.

As another example, the imaging lens system, according to an embodiment of the present disclosure, may include a lens having negative refractive power. For example, in the imaging lens system, according to an embodiment of the present disclosure, the foremost lens disposed closest to the object may have negative refractive power.

As another example, the imaging lens system, according to an embodiment of the present disclosure, may further satisfy a unique conditional expression. For example, the imaging lens system according to an embodiment of the present disclosure may satisfy the conditional expression −1.50≤fF/f≤−1.20. In the conditional expression, fF is a focal length of the foremost lens.

As another example, the imaging lens system, according to an embodiment of the present disclosure, may include optical path converter. For example, according to an embodiment of the present disclosure in the imaging lens system, the first lens group may include an optical path converter disposed on an image side of the lens.

An imaging lens system, according to an embodiment of the present disclosure, may include two lens groups. For example, the imaging lens system, according to an embodiment of the present disclosure, may include a first lens group and a second lens group sequentially arranged from an object side. The imaging lens system, according to an embodiment of the present disclosure, may include a lens group movable in an optical axis direction. For example, in the imaging lens system according to an embodiment of the present disclosure, the second lens group may be configured to be movable in the optical axis direction. Accordingly, the imaging lens system according to an embodiment of the present disclosure may adjust focus through driving the second lens group.

The imaging lens system according to an embodiment of the present disclosure may have unique optical characteristics. For example, the imaging lens system according to an embodiment of the present disclosure may have an f number of 2.0 or less and a half of field of view (HFOV) of 30 degrees or more. However, in the imaging lens system with the above-described angle of view and f number, aberration may rapidly increase. An embodiment of the present disclosure may include a lens having negative refractive power so that aberrations may be reduced. For example, in the imaging lens system according to an embodiment of the present disclosure, the foremost lens disposed closest to the object may have negative refractive power.

The imaging lens system, according to an embodiment of the present disclosure, may be configured to enable the miniaturization of the camera module. For example, the imaging lens system, according to an embodiment of the present disclosure, may include an optical path converter. As a specific example, in the imaging lens system according to an embodiment of the present disclosure, the optical path converter may be included in the first lens group. However, if a plurality of lenses are disposed on the object side of the optical path converter, the problem of increasing the optical path converter may occur. Therefore, it may be desirable that one lens is disposed on the object side of the optical path converter. The optical path converter may be in the form of a prism or reflector.

The imaging lens system, according to an embodiment of the present disclosure, may include a lens with a convex object-side surface, if desired. For example, in the imaging lens system according to an embodiment of the present disclosure, the foremost lens disposed on the object side of the optical path converter may have a convex object-side surface. The foremost lens of the above-described shape may be advantageous for thinning the imaging lens system.

The imaging lens system, according to an embodiment of the present disclosure, may include a lens with positive refractive power as needed. For example, in the imaging lens system according to an embodiment of the present disclosure, the first rear lens disposed closest to the image side of the optical path converter may have positive refractive power. The first rear lens may perform a function of reducing the overall aperture (effective aperture) of the second lens group. In addition, the first rear lens having a positive refractive power may be advantageous in reducing the amount of movement of the first lens group when correcting hand shake of the camera module.

According to an embodiment of the present disclosure, the imaging lens system may include a lens with an inflection point as needed. For example, according to an embodiment of the present disclosure in the imaging lens system, the rearmost lens closest to the imaging plane may have an inflection point formed on at least one of the object-side surface and the image-side surface. The rearmost lens of this shape may be advantageous in satisfying the CRA (Chief Ray Angle) of the rays formed on the imaging plane.

In the imaging lens system, according to the second form, the number of lenses constituting the second lens group may be greater than the number of lenses constituting the first lens group. For example, in the imaging lens system according to the second type, the first lens group may have two lenses (excluding the optical path converter), and the second lens group may have four or five lenses. A second lens group that satisfies the above-described relationship may be advantageous in correcting aberrations caused by the first lens group.

An imaging lens system, according to an embodiment of the present disclosure, may include a plurality of lenses. For example, the imaging lens system, according to an embodiment of the present disclosure, may include a first lens, a second lens, a third lens, a fourth lens, a fifth lens, and a sixth lens arranged sequentially from an object side. However, the number of lenses constituting the imaging lens system, according to an embodiment of the present disclosure, is not limited to six. For example, the imaging lens system, according to an embodiment of the present disclosure, may further include a seventh lens disposed on an image side of the sixth lens. As another example, the imaging lens system according to an embodiment of the present disclosure may further include a seventh lens and an eighth lens sequentially disposed on the image side of the sixth lens. The imaging lens system according to the third form aspect satisfy a unique conditional expression. For example, the imaging lens system according to an embodiment of the present disclosure may satisfy the conditional expression 2.80≤f2/f≤4.0 and 1.40<D12/f<2.20. In the conditional expression, f2 is a focal length of the second lens, and D12 is a distance from the image-side surface of the first lens to the object-side surface of the second lens.

The imaging lens system, according to an embodiment of the present disclosure, may include a plurality of lens groups. For example, according to an embodiment of the present disclosure, the imaging lens system may include a first lens group and a second lens group sequentially arranged from an object side. The imaging lens system, according to an embodiment of the present disclosure, may satisfy one or more of the following conditional expressions:

$$f number \leq 2. \qquad 1 )$$

$$30 ° \leq HFOV \qquad 2 )$$

$$- 1.5 \leq fF / f \leq - 1.2 \qquad 3 )$$

$$0.2 \leq T 1 / SL 1 \leq 0.4 \qquad 4 )$$

$$0.7 \leq Dp / 2 Y \leq 1.2 \qquad 5 )$$

$$1.2 \leq LG 2 R 1 / f \leq 1.5 \qquad 6 )$$

$$0.6 \leq L 1 ST / STY \leq 1.8 \qquad 7 )$$

$$\vert f / fR \vert \leq 0.15 \qquad 8 )$$

$$0.9 \leq EDLF / EDLR \leq 1.2 \qquad 9 )$$

$$2.8 \leq fG 1 R / f \leq 4. \qquad 10 )$$

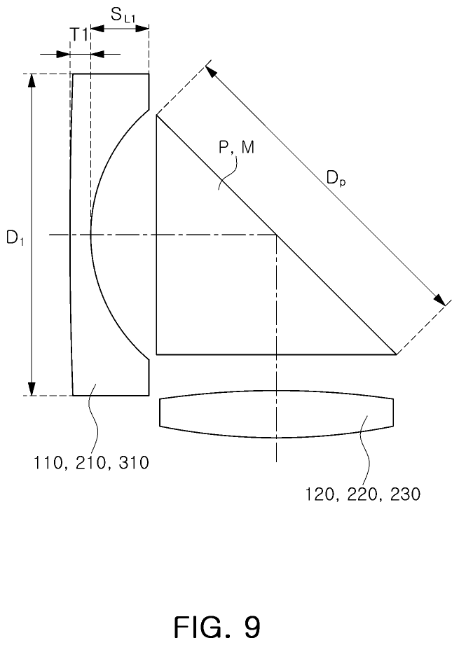

In the above conditional expression, f is a focal length of the imaging lens system, fF is a focal length of the foremost lens disposed closest to an object, T1 is a thickness at the center of an optical axis of the foremost lens, SL1 is a sag value of an image-side surface of the foremost lens (see FIG. 9), Dp is a length of a reflecting surface of an optical path converter, 2Y is a diagonal length of an imaging plane, LG2R1 is a radius of curvature of the object-side surface of a second front lens disposed closest to an object in the second lens group, L1ST is a distance from the object-side surface of the foremost lens to a stop, STY is a distance from the stop to the imaging plane, fR is a focal length of a rearmost lens disposed closest to the imaging plane, EDLF is an effective diameter of the foremost lens, EDLR is an effective diameter of the rearmost lens, and fG1R is a focal length of a lens disposed closest to the imaging plane in the first lens group (or a lens closest to the image side of the optical path converter).

Conditional Equation 3 may provide a numerical range for limiting the refractive power of a foremost lens. For example, it is difficult to implement an imaging lens system with a wide angle of view for a foremost lens exceeding the lower limit value of Conditional Equation 3. As another example, a foremost lens exceeding the upper limit value of Conditional Equation 3 may be advantageous in implementing an imaging lens system with a wide angle of view, but it may be difficult to implement a high-resolution imaging lens system because aberration correction is difficult.

Conditional Equation 4 may provide a numerical range to limit the shape of the foremost lens. For example, the foremost lens exceeding the lower limit value of Conditional Equation 4 may be difficult to manufacture due to its thin thickness, or the sag value of the image-side surface of the foremost lens may be excessively increased. As another example, a foremost lens exceeding the upper limit value of Conditional Equation 4 may be easy to manufacture, but it may be difficult to implement an imaging lens system with a wide angle of view.

Conditional Equation 5 may provide a numerical range for limiting the performance and size of the imaging lens system. For example, an optical path converter exceeding the lower limit value of Conditional Equation 5 may cause unnecessary vignetting and make it difficult to implement a bright optical system. As another example, an optical path converter exceeding the upper limit value of Conditional Equation 5 increases the overall size of the imaging lens system, making it difficult to apply to a small camera module.

Conditional Equation 6 may provide a numerical range for limiting the aberration characteristics and size of the imaging lens system. For example, a second front lens exceeding the lower limit value of Conditional Equation 6 may increase the aberration of the imaging lens system. As another example, a second front lens exceeding the upper limit value of Conditional Equation 6 may weaken the refractive power of the second lens group, thereby making it difficult to adjust the focus through the second lens group. In addition, the second front lens exceeding the upper limit of Conditional Equation 6 increases the amount of movement of the second lens group for focus adjustment, thereby making it difficult to miniaturize the imaging lens system.

Conditional Expression 7 may provide a numerical range for limiting the position of a stop. For example, a stop exceeding the lower limit value of Conditional Equation 7 may be disposed too close to an object, which may be a problem of increasing a size (e.g., effective diameter) of a rearmost lens. As another example, a stop exceeding the upper limit value of Conditional Equation 7 may have a problem of increasing a size (e.g., effective diameter) of the foremost lens. To elaborate, a stop exceeding the numerical range of Conditional Equation 7 may make it difficult to miniaturize the imaging lens system in the camera module.

Conditional Equation 8 may provide a numerical range for limiting a focal length of a rearmost lens. For example, a rearmost lens exceeding the upper limit value of Conditional Equation 8 may have difficulty performing a field curvature correction function, thereby worsening the aberration characteristics of the optical system.

Conditional Equation 9 may provide a numerical range for the miniaturization of an imaging lens system. For example, an imaging lens system, exceeding the numerical range of Conditional Expression 9, may have an excessively large difference in effective diameter between the foremost lens and the rearmost lens, making it difficult to miniaturize the imaging lens system.

A camera module including an optical system, according to an embodiment of the present disclosure, may have a wide angle of view and a low f number, so an image stabilization function may not be desired when capturing outdoor images, but an image shake correction function may be needed when capturing photos at night or indoors. In this case, it may be desirable to configure the lens disposed closest to an imaging plane in the first lens group (or the lens closest to an image side of the optical path converter) to be responsible for camera shake correction. Conditional Equation 10 provides a numerical range to limit the aberration stability of the correction lens responsible for camera shake correction. For example, a correction lens exceeding the lower limit value of Conditional Equation 10 may have a small refractive power, which can lead to an increase in the desired movement for hand shake correction. As another example, a correction lens exceeding the upper limit value of Conditional Equation 10 may have a problem of increasing aberration of the imaging lens system. On the other hand, a correction lens that satisfies Condition Equation 10 may stably maintain the resolution of the imaging lens system during movements desired for camera shake correction.

According to an embodiment of the present disclosure, an imaging lens system includes a plurality of lenses arranged sequentially from an object side, and may satisfy one or more of the following conditional expressions. For example, the imaging lens system, according to the fifth aspect, includes a first lens, a second lens, a third lens, a fourth lens, a fifth lens, and a sixth lens arranged sequentially from the object side, or it may include a first lens, a second lens, a third lens, a fourth lens, a fifth lens, a sixth lens, and a seventh lens arranged sequentially from the object side and may satisfy one or more of the following conditional expressions.

$$1.4 < D 12 / f < 2.2 \qquad 11 )$$

$$8. < R 1 / R 2 < 20 \qquad 12 )$$

$$- 3. < ( R 1 + R 4 ) / ( R 2 + R 3 ) < 3.1 \qquad 13 )$$

$$0.8 < R 5 / R 7 < 1.6 \qquad 14 )$$

$$- 6. < ( R 3 + R 12 ) / R 8 < - 1. \qquad 15 )$$

$$- 3. < ( R 3 + R 12 ) / ( R 8 + R 9 ) < - 0.8 \qquad 16 )$$

In the above Conditional Expression, D12 is a distance from an image-side surface of a first lens to an object-side surface of a second lens, R1 is a radius of curvature of an object-side surface of a first lens, R2 is a radius of curvature of the image-side surface of the first lens, R3 is a radius of curvature of the object-side surface of the second lens, R4 is a radius of curvature of the image-side surface of the second lens, R5 is a radius of curvature of an object-side surface of a third lens, R7 is a radius of curvature of an object-side surface of a fourth lens, R8 is a radius of curvature of an image-side surface of the fourth lens, R9 is a radius of curvature of an object-side surface of a fifth lens, and R12 is a radius of curvature of an image-side surface of a sixth lens.

Conditional Equation 11 may be a numerical range for limiting the shape of the first lens group. For example, it may be difficult for an imaging lens system exceeding the lower limit value of Conditional Equation 11 to form a first lens group including an optical path converter. As another example, it may be difficult to miniaturize an imaging lens system exceeding the upper limit value of Conditional Equation 11.

Conditional Expression 12 may be a numerical range for limiting the shape of the object-side surface of the foremost lens (or the first lens). For example, it may be difficult to correct aberration for a foremost lens exceeding the lower limit of Conditional Equation 12, and it may be difficult to manufacture a foremost lens exceeding the upper limit value of Conditional Equation 12.

Conditional Expressions 13 to 16 may be numerical ranges for improving aberration characteristics. For example, in an imaging lens system exceeding the numerical range of Conditional Expressions 13 to 16, it may be difficult to perform aberration correction through the first to sixth lenses.

According to an embodiment of the present disclosure, an imaging lens system includes a plurality of lenses arranged sequentially from an object side and may satisfy one or more of the following conditional expressions. For example, the imaging lens system, according to an embodiment of the present disclosure, may include a first lens, a second lens, a third lens, a fourth lens, a fifth lens, and a sixth lens arranged sequentially from the object side, or it may include a first lens, a second lens, a third lens, a fourth lens, a fifth lens, a sixth lens, and a seventh lens, and may satisfy one or more of the following conditional expressions.

$$- 0.6 < f 1 / f 2 < - 0.1 \qquad 17 )$$

$$0.6 < ( f 1 + f 2 ) / f 3 < 1.2 \qquad 18 )$$

$$- 1.2 < ( f 1 + f 5 ) / f 3 < - 0.8 \qquad 19 )$$

$$0.8 < f 1 / f 5 < 1.6 \qquad 20 )$$

$$0.8 < ( f 3 + f 4 ) / f 2 < 1.6 \qquad 21 )$$

$$- 1.5 < ( f 3 - f 4 ) / f 5 < - 0.3 \qquad 22 )$$

$$0.4 < ( f 3 + f 5 ) / f 4 < 1.4 \qquad 23 )$$

$$1. < ( f 1 + f 2 ) / R 5 < 1.8 \qquad 24 )$$

$$1. < ( f 2 + R 12 ) / ( f 3 + R 12 ) < 1.4 \qquad 25 )$$

In the above Conditional Expression, f1 is a focal length of a first lens, f2 is a focal length of a second lens, f3 is a focal length of a third lens, f4 is a focal length of a fourth lens, and f5 is a focal length of a fifth lens.

Conditional Expressions 17 to 25 may be numerical ranges for limiting the size of the refractive power of the first to sixth lenses. For example, the first to sixth lenses which are outside the numerical range of Conditional Expressions 17 to 25 may make it difficult to implement an imaging lens system with a wide angle of view or a bright imaging lens system. As another example, for the shape outside the numerical range of Conditional Expressions 17 to 25, the resolution of the optical system may be greatly reduced due to a rapid increase in aberration.

According to a seventh aspect, an imaging lens system may be configured to include two or more features according to the embodiments of the present disclosure. As an example, according to an embodiment of the present disclosure, the imaging lens system may include the characteristics of the first form and satisfy one or more of the conditional expressions according to the fifth form. As another example, according to an embodiment of the present disclosure, the imaging lens system may include the characteristics of the second form and satisfy one or more conditional expressions.

According to the present disclosure, an imaging lens system may include one or more lenses with the following characteristics as desired. As an example, according to an embodiment of the present disclosure, the imaging lens system may include one of the first to eighth lenses according to the following characteristics. As another example, according to the second to seventh aspects, the imaging lens system may include one or more of the first to eighth lenses according to the following characteristics. However, according to the above-described lens, the imaging lens system does not necessarily include a lens according to the following characteristics. Below, the characteristics of the first to eighth lenses will be described.

The first lens may have refractive power. For example, the first lens may have negative refractive power. The first lens may have a convex shape on one surface. For example, the first lens may have a convex object-side surface. The first lens may include a spherical or aspherical surface. For example, both surfaces of the first lens may be aspherical.

The first lens may be made of a material with high light transmittance and excellent processability. For example, the first lens may be made of plastic or glass. The first lens may be configured to have a predetermined refractive index. For example, the refractive index of the first lens may be greater than 1.5. As a specific example, the refractive index of the first lens may be greater than 1.50 and less than 1.6. The first lens may have a predetermined Abbe number. For example, the Abbe number of the first lens may be 50 or more.

The second lens may have refractive power. For example, the second lens may have positive refractive power. The second lens may have a convex shape on one surface. For example, the second lens may have a convex object-side surface. The second lens may include a spherical or aspherical surface. For example, both surfaces of the second lens may be aspherical. The second lens may be made of material with high light transmittance and excellent processability. For example, the second lens may be formed of a plastic material or glass. The second lens may be configured to have a predetermined refractive index. For example, the refractive index of the second lens may be greater than 1.5. The second lens may have a predetermined Abbe number. For example, the Abbe number of the second lens may be 50 or more.

The third lens may have refractive power. For example, the third lens may have positive refractive power. The third lens may have a convex shape on one surface. For example, the third lens may have a convex object-side surface. The third lens may include a spherical or aspherical surface. For example, both surfaces of the third lens may be aspherical. The third lens may be made of a material with high light transmittance and excellent processability. For example, the third lens may be made of plastic. The third lens may be configured to have a predetermined refractive index. For example, the refractive index of the third lens may be greater than 1.5. The third lens may have a predetermined Abbe number. For example, the Abbe number of the third lens may be greater than 50.

The fourth lens may have refractive power. For example, the fourth lens may have positive refractive power. The fourth lens may have a convex shape on one surface. For example, the fourth lens may have a convex object-side surface. The fourth lens may include a spherical or aspherical surface. For example, both sides of the fourth lens may be spherical. The fourth lens may be made of material that has high light transmittance and excellent processability. For example, the fourth lens may be made of plastic. The fourth lens may have a predetermined refractive index. For example, the refractive index of the fourth lens may be less than 1.52.

The fifth lens may have refractive power. For example, the fifth lens may have negative refractive power. The fifth lens may have a concave shape on one surface. As an example, the fifth lens may have a concave object-side surface. The fifth lens may include a spherical or aspherical surface. For example, both surfaces of the fifth lens may be spherical. The fifth lens may be formed of a material having high light transmittance and excellent processability. For example, the fifth lens may be made of plastic. The fifth lens may have a predetermined refractive index. As an example, the refractive index of the fifth lens may be greater than 1.8.

The sixth lens may have refractive power. For example, the sixth lens may have positive or negative refractive power. The sixth lens may have a convex shape on one surface. As an example, the sixth lens may have a convex object-side surface. The sixth lens may include a spherical or aspherical surface. For example, both surfaces of the sixth lens may be aspherical. The sixth lens may have a shape with an inflection point. For example, an inflection point may be formed on at least one of the object-side surface and the image-side surface of the sixth lens. The sixth lens may be made of a material with high light transmittance and excellent processability. For example, the sixth lens may be made of plastic. The sixth lens may be configured to have a predetermined refractive index. As an example, the refractive index of the sixth lens may be less than 1.7.

The seventh lens may have refractive power. For example, the seventh lens may have positive refractive power. The seventh lens may have a convex shape on one surface. As an example, the seventh lens may have a convex object-side surface. The seventh lens may include a spherical or aspherical surface. For example, both surfaces of the seventh lens may be aspherical. The seventh lens may have a shape with an inflection point. For example, an inflection point may be formed on at least one of the object-side surface and the image-side surface of the seventh lens. The seventh lens may be formed of a material having high light transmittance and excellent processability. For example, the seventh lens may be made of plastic. The seventh lens may be configured to have a predetermined refractive index. As an example, the refractive index of the seventh lens may be greater than 1.5. The seventh lens may have a predetermined Abbe number. For example, the Abbe number of the seventh lens may be greater than 50.

The eighth lens may have refractive power. For example, the eighth lens may have positive refractive power. The eighth lens may have a convex shape on one surface. As an example, the eighth lens may have a convex object-side surface. The eighth lens may include a spherical or aspherical surface. For example, both surfaces of the eighth lens may be aspherical. The eighth lens may be formed of a material having high light transmittance and excellent processability. For example, the eighth lens may be formed of a plastic material. The eighth lens may be configured to have a predetermined refractive index. As an example, the refractive index of the eighth lens may be greater than 1.5. The eighth lens may have a predetermined Abbe number. As an example, the Abbe number of the eighth lens may be greater than 50.

As described above, the first to eighth lenses may include a spherical surface or an aspherical surface. When the first to eighth lenses include an aspheric surface, the aspherical surface of the corresponding lens may be expressed by Equation 1.

$$z = \frac{{cr}^{2}}{1 + \sqrt{1 - ( 1 + k ) {c}^{2} {r}^{2}}} + {Ar}^{4} + {Br}^{6} + {Cr}^{8} + {Dr}^{10} + {Er}^{12} + {Fr}^{14} + {Gr}^{16} + {Hr}^{18} + {Jr}^{20} \qquad [ Equation 1 ]$$

In Equation 1, c is the reciprocal of the radius of curvature of a corresponding lens, k is a conic constant, r is a distance from any point on an aspherical surface to an optical axis, A to J are aspherical surface constants, and Z (or SAG) is a height in an optical axis direction from a certain point on the aspherical surface to a vertex of the corresponding aspherical surface.

An imaging lens system according to the above-described embodiment or the above-described form may further include a stop and a filter. The stop may be disposed between the first and second lens groups or between the third and fourth lenses. The filter may be disposed between the rearmost lens (sixth, seventh, or eighth lens) and the imaging plane. Filters may be configured to block light of specific wavelengths. For reference, the filter described in the present specification is configured to block infrared rays, but the wavelength of light blocked through the filter is not limited to infrared rays.

Hereinafter, specific embodiments of the present disclosure will be described in detail based on the attached drawings.

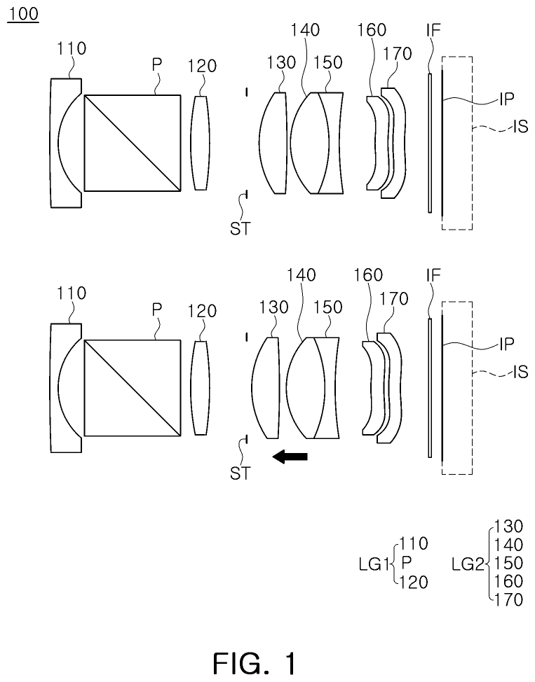

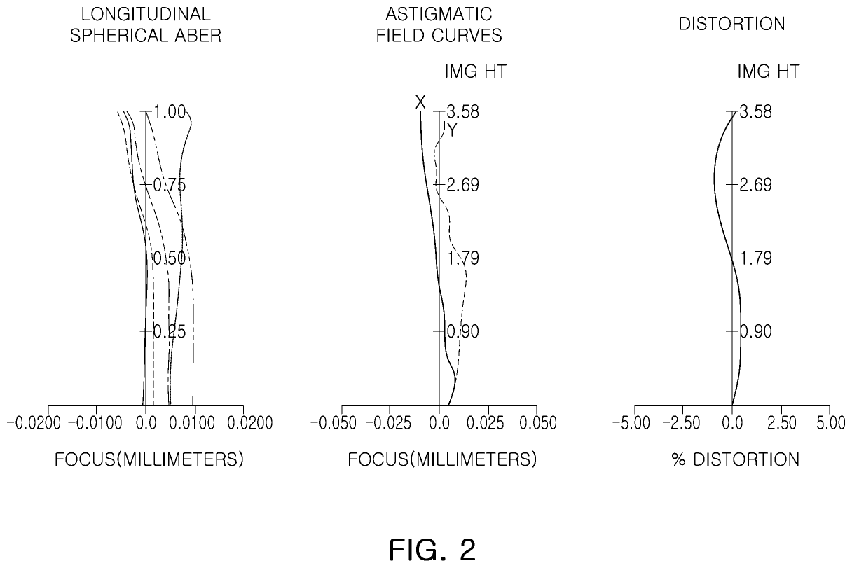

First, an imaging lens system according to an embodiment will be described with reference to FIGS. 1 and 2.

The imaging lens system 100 may have a plurality of lens groups. For example, the imaging lens system 100 may include a first lens group (LG1) and a second lens group (LG2). The first lens group LG1 and the second lens group LG2 may be arranged sequentially from an object side. The first lens group (LG1) and the second lens group (LG2) may include one or more lenses. For example, the first lens group (LG1) may have two lenses, and the second lens group (LG2) may have five lenses.

The first lens group LG1 may have a first lens 110 and a second lens 120. The first lens 110 may have negative refractive power, and may have a convex object-side surface and concave image-side surface. The second lens 120 may have positive refractive power and may have a convex object-side surface and convex image-side surface. The first lens group LG1 may include an optical path converter. For example, the first lens group LG1 may include a prism P disposed between the first lens 110 and the second lens 120. For reference, in the present embodiment, a prism (P) is illustrated as a type of optical path converter, but it may also be possible to change the optical path converter to a reflector.

The second lens group LG2 may have a third lens 130, a fourth lens 140, a fifth lens 150, a sixth lens 160, and a seventh lens 170. The third lens 130 may have positive refractive power and may have a convex object-side surface and convex image-side surface. The fourth lens 140 may have positive refractive power and may have a convex object-side surface and convex image-side surface. The fifth lens 150 may have negative refractive power and may have a concave object-side surface and concave image-side surface. The sixth lens 160 may have negative refractive power and may have a convex object-side surface and concave image-side surface. The seventh lens 170 may have positive refractive power and may have a convex object-side surface and concave image-side surface.

The second lens group LG2 may be configured to be movable in the optical axis direction. Therefore, according to the embodiment, the imaging lens system 100 may enable focus adjustment (AF) of the camera module through the movement of the second lens group LG2. Specifically, in the present embodiment, the change in the size of a focal length (f) due to movement of the second lens group LG2 may be very slight. Therefore, the imaging lens system 100, according to the present embodiment may implement resolution of a constant quality even if the focus is adjusted through the second lens group LG2.

The imaging lens system 100 may further include other lens elements in addition to the first lens 110 to the seventh lens 170. For example, the imaging lens system 100 may further include a stop (ST), a filter (IF), and an imaging plane (IP). The stop (ST) may be disposed between the first lens group LG1 and the second lens group LG2. The filter (IF) may be disposed between the seventh lens 170 and the imaging plane (IP). The imaging plane (IP) may be formed in a location in which light incident from the first lens 110 to the seventh lens 170 forms an image. For example, the imaging plane (IP) may be formed on one surface of the image sensor (IS) of a camera module or on a lens element disposed inside the image sensor (IS).

FIG. 2 illustrates aberration characteristics of an imaging lens system 100 according to the present embodiment. Tables 1 and 2 illustrate lens characteristics of the imaging lens system according to the present embodiment, and Table 3 illustrates lens characteristics and aspherical values of the imaging lens system according to the present embodiment.

TABLE 1

| Surface | | Curvature | Thickness/ | Refractive | | Effective |
|---|---|---|---|---|---|---|
| No. | Component | Radius | Distance | Index | Abbe No. | Radius |
| S0 | object | infinity | D0 | | | |
| S1 | 1st Lens | 26.3720 | 0.400 | 1.544 | 55.900 | 3.430 |
| S2 | | 2.7700 | 1.470 | | | 2.640 |
| S3 | prism | infinity | 2.600 | 1.744 | 44.900 | 2.600 |
| S4 | | infinity | 2.600 | 1.744 | 44.900 | 3.680 |
| S5 | | infinity | 0.500 | | | 2.600 |
| S6 | 2nd Lens | 11.6280 | 1.000 | 1.535 | 55.700 | 2.500 |
| S7 | | −25.2400 | 1.679 | | | 2.530 |
| S8 | stop | infinity | D1 | | | 2.550 |
| S9 | 3rd Lens | 5.5790 | 1.500 | 1.535 | 55.700 | 2.700 |
| S10 | | −24.9960 | 0.164 | | | 2.700 |
| S11 | 4th Lens | 4.0550 | 2.080 | 1.497 | 81.600 | 2.700 |
| S12 | 5th Lens | −6.3450 | 0.500 | 2.003 | 28.300 | 2.700 |
| S13 | | 15.1740 | 2.006 | | | 2.700 |
| S14 | 6th Lens | 47.6050 | 0.700 | 1.671 | 19.200 | 2.260 |
| S15 | | 17.5680 | 0.189 | | | 2.510 |
| S16 | 7th Lens | 4.2370 | 0.700 | 1.535 | 55.700 | 2.500 |
| S17 | | 5.0180 | D2 | | | 3.000 |
| S18 | Filter | infinity | 0.210 | 1.517 | 64.200 | |
| S19 | | infinity | D3 | | | |
| S20 | Imaging | infinity | D4 | | | 3.584 |
| | plane | | | | | |

TABLE 2

| | 1st position | 2nd position |
|---|---|---|
| D0 | infinity | 80.1928 |
| D1 | 1.0120 | 0.8017 |
| D2 | 1.2310 | 1.4413 |
| D3 | 0.5046 | 0.5061 |
| D4 | −0.0046 | −0.0061 |
| f | 4.047 | 4.072 |
| MAG | 0 | 0.05 |
| HFOV | 41.5 | 40.5 |
| f number | 1.69 | 1.73 |
| TTL | 21.041 | 21.041 |

TABLE 3

| Surface No. | S1 | S2 | S6 | S7 | S8 |
|---|---|---|---|---|---|
| K | −1.000E+02 | −1.944E+00 | −6.302E+00 | −1.000E+02 | 1.815E−01 |
| A | −2.144E−04 | 7.066E−03 | 3.400E−04 | −7.162E−04 | 1.584E−03 |
| B | −4.638E−06 | 1.694E−05 | −6.073E−06 | −3.126E−06 | −6.567E−06 |
| C | −1.390E−05 | −5.238E−05 | −2.356E−05 | −1.607E−05 | 7.980E−07 |
| D | 2.809E−06 | 1.457E−05 | 3.303E−06 | 1.719E−06 | −8.453E−09 |
| E | −3.289E−07 | −2.758E−06 | −1.479E−07 | 1.074E−07 | 3.714E−09 |
| F | 0 | 0 | 0 | 0 | 0 |
| G | 0 | 0 | 0 | 0 | 0 |
| H | 0 | 0 | 0 | 0 | 0 |
| J | 0 | 0 | 0 | 0 | 0 |
| L | 0 | 0 | 0 | 0 | 0 |
| M | 0 | 0 | 0 | 0 | 0 |
| N | 0 | 0 | 0 | 0 | 0 |
| O | 0 | 0 | 0 | 0 | 0 |
| P | 0 | 0 | 0 | 0 | 0 |

| Surface No. | S9 | S14 | S15 | S16 | S17 |
|---|---|---|---|---|---|
| K | −1.000E+02 | −2.500E+01 | −1.000E+02 | −1.000E+02 | −1.000E+02 |
| A | 5.315E−04 | −6.786E−03 | −8.224E−03 | 1.362E−02 | 9.478E−03 |
| B | 5.469E−05 | −1.117E−03 | −1.467E−03 | −8.502E−03 | −5.281E−03 |
| C | −1.171E−05 | 1.627E−04 | 4.112E−04 | 1.923E−03 | 1.034E−03 |
| D | 6.806E−07 | −5.050E−05 | −9.756E−05 | −4.035E−04 | −1.883E−04 |
| E | −2.079E−08 | 1.567E−05 | 1.944E−05 | 7.315E−05 | 2.960E−05 |
| F | 0 | 0 | 0 | −1.027E−05 | −3.667E−06 |
| G | 0 | 0 | 0 | 1.024E−06 | 3.419E−07 |
| H | 0 | 0 | 0 | −6.645E−08 | −2.351E−08 |
| J | 0 | 0 | 0 | 2.268E−09 | 1.178E−09 |
| L | 0 | 0 | 0 | 1.325E−11 | −4.232E−11 |
| M | 0 | 0 | 0 | −5.158E−12 | 1.060E−12 |
| N | 0 | 0 | 0 | 2.330E−13 | −1.755E−14 |
| O | 0 | 0 | 0 | 0 | 1.739E−16 |
| P | 0 | 0 | 0 | 0 | −3.673E−18 |

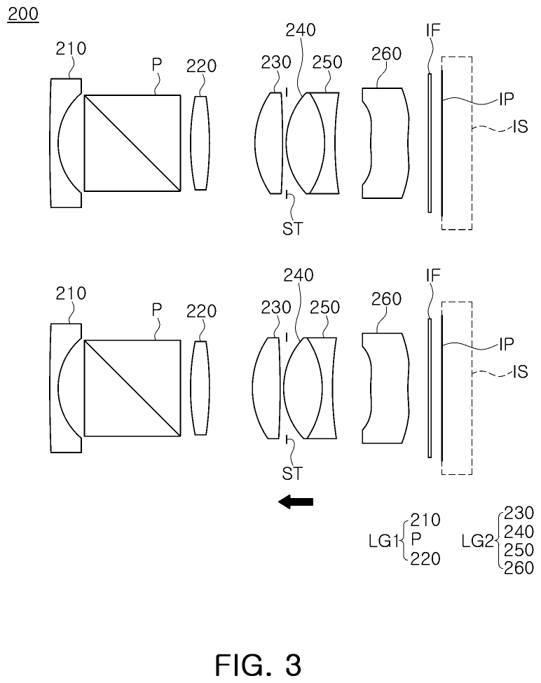

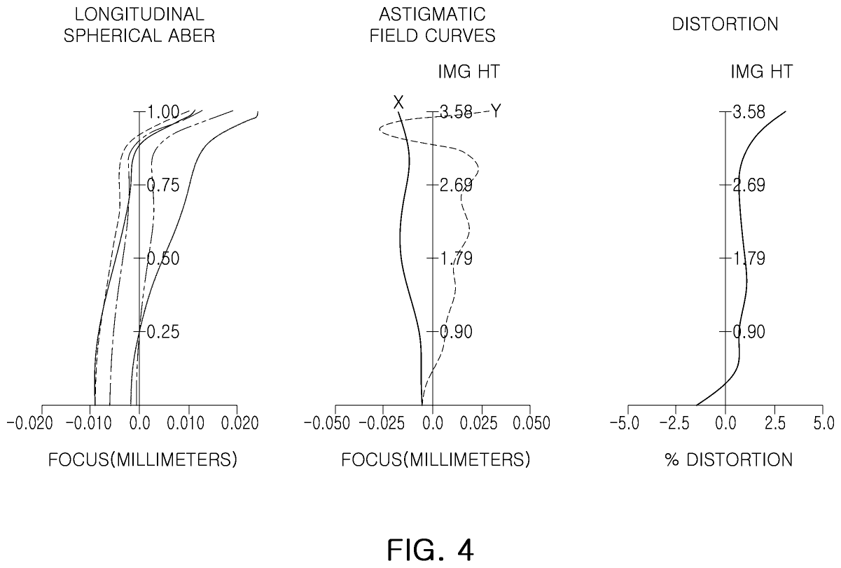

An imaging lens system according to an embodiment will be described with reference to FIGS. 3 and 4.

The imaging lens system 200 may include a plurality of lens groups. For example, the imaging lens system 200 may include a first lens group (LG1) and a second lens group (LG2). The first lens group LG1 and the second lens group LG2 may be arranged sequentially from an object side. The first lens group (LG1) and the second lens group (LG2) may include one or more lenses. For example, the first lens group (LG1) may have two lenses, and the second lens group (LG2) may have four lenses.

The first lens group LG1 may include a first lens 210 and a second lens 220. The first lens 210 may have negative refractive power and may have a convex object-side surface and a concave image-side surface. The second lens 220 may have positive refractive power and may have a convex object-side surface and a convex image-side surface. The first lens group LG1 may include an optical path converter (P). For example, the first lens group LG1 may include a prism (P) disposed between the first lens 210 and the second lens 220. For reference, in the present embodiment, a prism (P) is illustrated as a type of optical path converter, but use of a reflector as the optical path converter may also be possible.

The second lens group LG2 may include a third lens 230, a fourth lens 240, a fifth lens 250, and a sixth lens 260. The third lens 230 may have positive refractive power and may have a convex object-side surface and a convex image-side surface. The fourth lens 240 may have positive refractive power and may have a convex object-side surface and a convex image-side surface. The fifth lens 250 may have negative refractive power and may have a concave object-side surface and a concave image-side surface. The sixth lens 260 may have negative refractive power and may have a convex object-side surface and a concave image-side surface.

The second lens group LG2 may be configured to be movable in an optical axis direction. Accordingly, the imaging lens system 200, according to the present embodiment, may enable focus adjustment (AF) of a camera module through the movement of the second lens group LG2. Specifically, in the present embodiment, the change in the size of the focal length (f) due to the movement of the second lens group LG2 may be very slight. Therefore, the imaging lens system 200 according to the present embodiment may implement resolution of a constant quality even if the focus is adjusted through the second lens group LG2.

The imaging lens system 200 may further include other lens elements in addition to the first lens 210 to the sixth lens 260. For example, the imaging lens system 200 may further include a stop (ST), a filter (IF), and an imaging plane (IP). The stop (ST) may be disposed between the third lens 230 and the fourth lens 240. The filter (IF) may be disposed between the sixth lens 260 and the imaging plane (IP). The imaging plane (IP) may be formed in a position in which light incident from the first lens 210 to the sixth lens 260 forms an image. For example, the imaging plane (IP) may be formed on one surface of an image sensor (IS) of the camera module or on a lens element disposed inside the image sensor (IS).

FIG. 4 illustrates aberration characteristics of the imaging lens system 200 according to the present embodiment. Tables 4 and 5 illustrate the lens characteristics of the imaging lens system according to the present embodiment, and Table 6 illustrates the lens characteristics and aspherical value of the imaging lens system according to the present embodiment.

TABLE 4

| Surface | | Curvature | Thickness/ | Refractive | | Effective |
|---|---|---|---|---|---|---|
| No. | Component | Radius | Distance | Index | Abbe No. | Radius |
| S0 | object | infinity | D0 | | | |
| S1 | 1st Lens | 33.2710 | 0.400 | 1.544 | 55.900 | 3.550 |
| S2 | | 2.7550 | 1.470 | | | 2.755 |
| S3 | prism | infinity | 2.600 | 1.744 | 44.900 | 2.600 |
| S4 | | infinity | 2.600 | 1.744 | 44.900 | 3.677 |
| S5 | | infinity | 0.500 | | | 2.600 |
| S6 | 2nd Lens | 8.3500 | 1.020 | 1.535 | 55.700 | 2.500 |
| S7 | | −61.1570 | D1 | | | 2.562 |
| S8 | 3rd Lens | 5.6260 | 1.500 | 1.535 | 55.700 | 2.700 |
| S9 | stop | −24.0450 | 0.100 | | | 2.700 |
| S10 | 4th Lens | 4.2420 | 2.070 | 1.497 | 81.600 | 2.700 |
| S11 | 5th Lens | −4.8370 | 0.500 | 2.003 | 28.300 | 2.700 |
| S12 | | 36.9320 | 1.976 | | | 2.700 |
| S13 | 6th Lens | 22.7830 | 1.980 | 1.535 | 55.700 | 2.245 |
| S14 | | 20.4910 | D2 | | | 3.000 |
| S15 | Filter | infinity | 0.210 | 1.517 | 64.200 | |
| S16 | | infinity | D3 | | | |
| S17 | Imaging | infinity | D4 | | | 3.584 |
| | plane | | | | | |

TABLE 5

| | 1st Position | 2nd Position |
|---|---|---|
| D0 | infinity | 100.0000 |
| D1 | 2.5844 | 2.4237 |
| D2 | 1.0316 | 1.1923 |
| D3 | 0.4935 | 0.4970 |
| D4 | 0.0065 | 0.0030 |
| f | 4.004 | 4.020 |
| MAG | 0.000 | 0.040 |
| HFOV | 42.964 | 42.249 |
| f number | 1.648 | 1.692 |
| TTL | 21.042 | 21.042 |

TABLE 6

| Surface No. | S1 | S2 | S6 | S7 |
|---|---|---|---|---|
| K | −1.000E+02 | −1.959E+00 | −6.975E+00 | −1.000E+02 |
| A | −4.382E−04 | 8.144E−03 | 2.057E−04 | −6.319E−04 |
| B | 4.407E−05 | −4.379E−05 | −6.202E−05 | −6.062E−05 |
| C | −1.176E−05 | 8.725E−07 | −3.087E−05 | −2.010E−05 |
| D | 1.169E−06 | 1.033E−10 | 3.971E−06 | 1.055E−06 |
| E | −3.836E−08 | −2.338E−09 | −4.306E−07 | 2.230E−08 |
| F | 0 | 0 | 0 | 0 |
| G | 0 | 0 | 0 | 0 |
| H | 0 | 0 | 0 | 0 |
| J | 0 | 0 | 0 | 0 |
| L | 0 | 0 | 0 | 0 |
| M | 0 | 0 | 0 | 0 |
| N | 0 | 0 | 0 | 0 |
| O | 0 | 0 | 0 | 0 |
| P | 0 | 0 | 0 | 0 |
| Surface No. | S8 | S9 | S13 | S14 |
| K | 3.650E−01 | −7.877E+01 | −2.500E+01 | −1.000E+02 |
| A | 1.769E−03 | 4.275E−04 | −1.795E−02 | −4.190E−03 |
| B | 2.352E−05 | 6.742E−05 | −2.566E−04 | −5.114E−04 |
| C | 1.029E−06 | −9.913E−06 | −1.567E−05 | 8.081E−05 |
| D | 8.257E−08 | 7.784E−07 | 1.209E−05 | −1.461E−05 |
| E | 6.812E−09 | −3.462E−08 | −7.633E−06 | 2.135E−06 |
| F | 0 | 0 | 2.903E−06 | −2.283E−07 |
| G | 0 | 0 | −6.984E−07 | 1.776E−08 |
| H | 0 | 0 | 1.113E−07 | −1.009E−09 |
| J | 0 | 0 | −1.207E−08 | 4.178E−11 |
| L | 0 | 0 | 8.960E−10 | −1.246E−12 |
| M | 0 | 0 | −4.487E−11 | 2.605E−14 |
| N | 0 | 0 | 0 | −3.612E−16 |
| O | 0 | 0 | 0 | 4.572E−18 |
| P | 0 | 0 | 0 | 1.260E−18 |

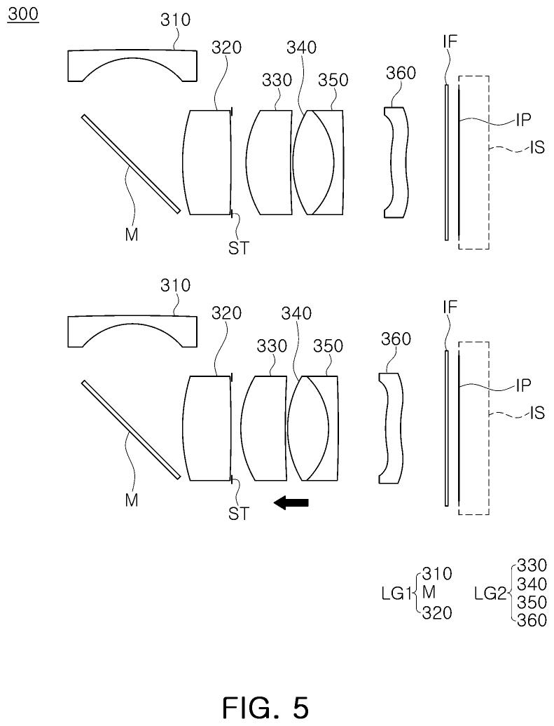

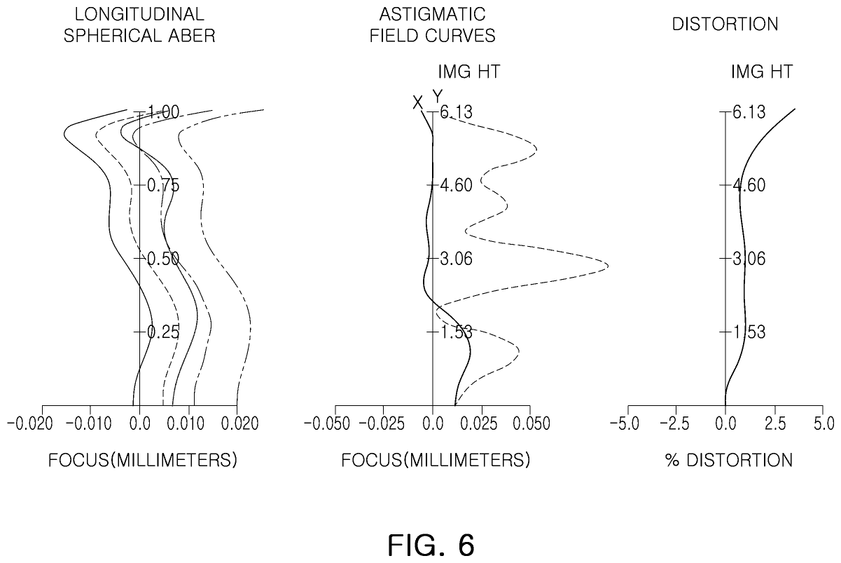

An imaging lens system according to an embodiment will be described with reference to FIGS. 5 and 6.

The imaging lens system 300 may include a plurality of lens groups. For example, the imaging lens system 300 may include a first lens group LG1 and a second lens group LG2. The first lens group LG1 and the second lens group LG2 may be arranged sequentially from an object side. The first lens group LG1 and the second lens group LG2 may include one or more lenses. For example, the first lens group LG1 may have two lenses, and the second lens group LG2 may have four lenses.

The first lens group LG1 may include a first lens 310 and a second lens 320. The first lens 310 may have negative refractive power and may have a convex object-side surface and a concave image-side surface. The second lens 320 may have positive refractive power and may have a convex object-side surface and a convex image-side surface. The first lens group LG1 may include an optical path converter. For example, the first lens group LG1 may include a reflector (M) disposed between the first lens 310 and the second lens 320. For reference, in the present embodiment, a reflector (M) is illustrated as a type of optical path converter, but it may also be possible to change the optical path converter to a prism.

The second lens group LG2 may include a third lens 330, a fourth lens 340, a fifth lens 350, and a sixth lens 360. The third lens 330 may have positive refractive power and may have a convex object-side surface and a convex image-side surface. The fourth lens 340 may have positive refractive power and may have a convex object-side surface and a convex image-side surface. The fifth lens 350 may have negative refractive power and may have a concave object-side surface and a convex image-side surface. The sixth lens 360 may have positive refractive power and may have a convex object-side surface and a concave image-side surface.

The second lens group LG2 may be configured to be movable in an optical axis direction. Accordingly, the imaging lens system 300, according to the present embodiment, may enable focus adjustment (AF) of a camera module through the movement of the second lens group LG2. Specifically, in the present embodiment, the change in the size of a focal length (f) due to movement of the second lens group LG2 may be very slight. Accordingly, the imaging lens system 300, according to the present embodiment may implement resolution of a constant quality even if the focus is adjusted through the second lens group LG2.

The imaging lens system 300 may further include other lens elements in addition to the first lens 310 to the sixth lens 360. For example, the imaging lens system 300 may further include a stop (ST), a filter (IF), and an imaging plane (IP). The stop (ST) may be disposed between the first lens group LG1 and the second lens group LG2. The filter (IF) may be disposed between the sixth lens 360 and the imaging plane (IP). The imaging plane (IP) may be formed in a location in which light incident from the first lens 310 to the sixth lens 360 forms an image. For example, the imaging plane (IP) may be formed on one surface of an image sensor (IS) of the camera module or on a lens element disposed inside the image sensor (IS).

FIG. 6 illustrates aberration characteristics of the imaging lens system 300 according to the present embodiment. Tables 7 and 8 illustrate lens characteristics of the imaging lens system according to the present embodiment, and Table 9 illustrates lens characteristics and aspherical values of the imaging lens system according to the present embodiment.

TABLE 7

| Surface | | Curvature | Thickness/ | Refractive | | Effective |
|---|---|---|---|---|---|---|
| No. | Component | Radius | Distance | Index | Abbe No. | Radius |
| S0 | object | infinity | D0 | | | |
| S1 | 1st Lens | 34.7660 | 0.600 | 1.544 | 55.900 | 5.121 |
| S2 | | 4.2150 | 6.000 | | | 3.890 |
| S3 | reflector | infinity | 4.200 | | | 5.374 |
| S4 | 2nd Lens | 14.2660 | 3.920 | 1.535 | 55.700 | 4.200 |
| S5 | stop | −80.1460 | D1 | | | 4.200 |
| S6 | 3rd Lens | 8.5170 | 3.730 | 1.535 | 55.700 | 4.200 |
| S7 | | −4699.1600 | 0.100 | | | 4.200 |
| S8 | 4th Lens | 8.0060 | 3.370 | 1.497 | 81.600 | 4.200 |
| S9 | 5th Lens | −5.8610 | 0.800 | 2.003 | 28.300 | 4.200 |
| S10 | | −103.6260 | 3.875 | | | 4.200 |
| S11 | 6th Lens | 8.9490 | 1.190 | 1.535 | 55.700 | 4.015 |
| S12 | | 10.7470 | D2 | | | 4.548 |
| S13 | Filter | infinity | 0.210 | 1.517 | 64.200 | |
| S14 | | infinity | D3 | | | |
| S15 | Imaging | infinity | D4 | | | 6.128 |
| | Plane | | | | | |

TABLE 8

| | 1st Position | 2nd Position |
|---|---|---|
| D0 | infinity | 100.0000 |
| D1 | 1.2278 | 0.7966 |
| D2 | 3.1777 | 3.6089 |
| D3 | 1.0110 | 1.0077 |
| D4 | −0.0110 | −0.0077 |
| f | 6.5577 | 6.5826 |
| MAG | 0.0000 | 0.0641 |
| HFOV | 42.1000 | 41.2000 |
| f number | 1.8805 | 1.9463 |
| TTL | 33.4005 | 33.4005 |

TABLE 9

| Surface No. | S1 | S2 | S4 | S5 |
|---|---|---|---|---|
| K | −1.000E+02 | −2.237E+00 | 6.259E+00 | −1.000E+02 |
| A | −3.531E−05 | 2.357E−03 | −3.285E−04 | 1.236E−05 |
| B | −1.218E−06 | −3.083E−05 | 2.338E−06 | −2.077E−06 |
| C | 1.109E−07 | −1.576E−07 | −7.585E−07 | 9.386E−07 |
| D | −3.296E−09 | 6.083E−08 | 3.314E−08 | −8.540E−08 |
| E | −3.529E−11 | −3.250E−09 | −9.878E−10 | 4.264E−09 |
| F | 0 | 1.072E−10 | 0 | 0 |
| G | 0 | −1.085E−12 | 0 | 0 |
| H | 0 | −1.298E−13 | 0 | 0 |
| J | 0 | 3.050E−15 | 0 | 0 |
| L | 0 | 0 | 0 | 0 |
| M | 0 | 0 | 0 | 0 |
| N | 0 | 0 | 0 | 0 |
| O | 0 | 0 | 0 | 0 |
| P | 0 | 0 | 0 | 0 |

| Surface No. | S6 | S7 | S11 | S12 |
|---|---|---|---|---|
| K | 2.440E−01 | −1.000E+02 | −2.500E+01 | −1.000E+02 |
| A | 2.769E−04 | 1.247E−04 | 1.632E−03 | 8.486E−03 |
| B | 3.040E−06 | −3.561E−06 | −2.965E−04 | −7.182E−04 |
| C | 9.084E−08 | 6.918E−08 | 1.901E−05 | 4.951E−05 |
| D | −1.178E−09 | −5.604E−10 | −6.077E−07 | −2.700E−06 |
| E | −3.171E−11 | −4.653E−10 | −6.435E−08 | 1.010E−07 |
| F | 0 | 0 | 1.013E−08 | −2.333E−09 |
| G | 0 | 0 | −6.874E−10 | 2.234E−11 |
| H | 0 | 0 | 2.881E−11 | 4.398E−13 |
| J | 0 | 0 | −8.077E−13 | −2.047E−14 |
| L | 0 | 0 | 0 | 3.781E−16 |
| M | 0 | 0 | 0 | −2.053E−18 |
| N | 0 | 0 | 0 | −2.480E−18 |
| O | 0 | 0 | 0 | −2.287E−20 |
| P | 0 | 0 | 0 | 1.836E−18 |

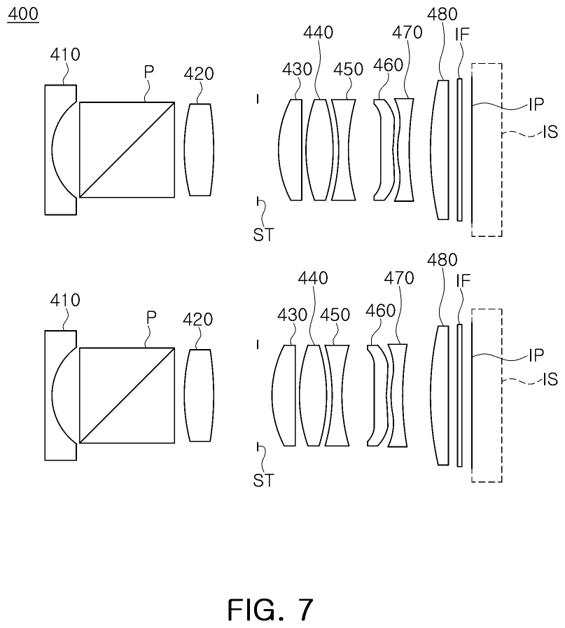

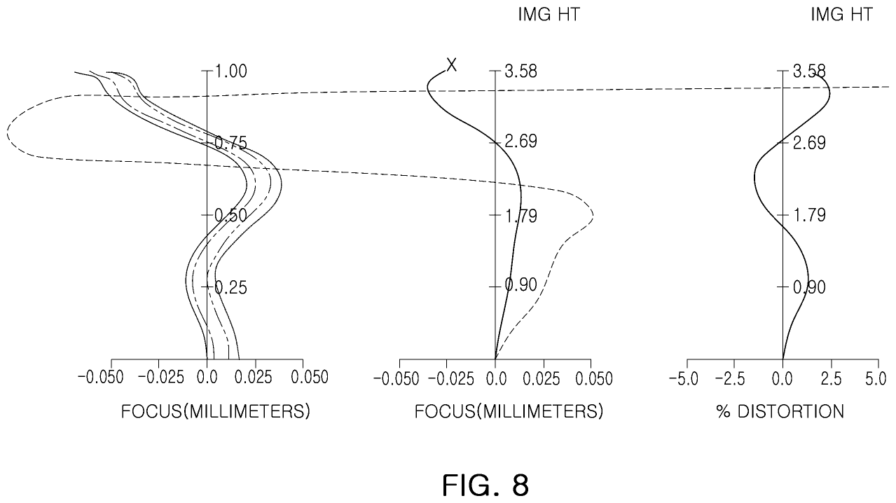

An imaging lens system according to an embodiment will be described with reference to FIGS. 7 and 8.

An imaging lens system 400 may include a plurality of lens groups. For example, the imaging lens system 400 may include a first lens group LG1 and a second lens group LG2. The first lens group LG1 and the second lens group LG2 may be arranged sequentially from an object side. The first lens group LG1 and the second lens group LG2 may include one or more lenses. For example, the first lens group LG1 may have two lenses, and the second lens group (LG2) may have six lenses.

The first lens group LG1 may include a first lens 410 and a second lens 420. The first lens 410 may have negative refractive power and may have a convex object-side surface and a concave image-side surface. The second lens 420 may have positive refractive power and may have a convex object-side surface and a convex image-side surface. The first lens group LG1 may include an optical path converter. For example, the first lens group LG1 may include a prism (P) disposed between the first lens 410 and the second lens 420. For reference, in the present embodiment, a prism (P) is illustrated as a type of optical path converter, but any other optical path converter, such as a reflector may be used.

The second lens group (LG2) may include a third lens 430, a fourth lens 440, a fifth lens 450, a sixth lens 460, a seventh lens 470, and an eighth lens 480. The third lens 430 may have positive refractive power and may have a convex object-side surface and a convex image-side surface. The fourth lens 440 may have positive refractive power and may have a convex object-side surface and a convex image-side surface. The fifth lens 450 may have negative refractive power and may have a concave object-side surface and a convex image-side surface. The sixth lens 460 may have negative refractive power and may have a convex object-side surface and a concave image-side surface. The seventh lens 470 may have positive refractive power and may have a convex object-side surface and a concave image-side surface. The eighth lens 480 may have positive refractive power and may have a convex object-side surface and concave image-side surface.

The second lens group LG2 may be configured to be movable in an optical axis direction. Therefore, according to the present embodiment, the imaging lens system 400 may enable focus adjustment (AF) of a camera module through movement of the second lens group LG2. Specifically, in the present embodiment, the change in the size of a focal length (f) due to movement of the second lens group LG2 may be very slight. Accordingly, the imaging lens system 400 according to the present embodiment may implement resolution of a constant quality even if the focus is adjusted through the second lens group LG2.

The imaging lens system 400 may further include other lens elements in addition to the first lens 410 to the eighth lens 480. For example, the imaging lens system 400 may further include a stop (ST), a filter (IF), and an imaging plane (IP). The stop (ST) may be disposed between the first lens group LG1 and the second lens group LG2. The filter (IF) may be disposed between the eighth lens 480 and the imaging plane (IP). The imaging plane (IP) may be formed where light incident from the first lens 410 to the eighth lens 480 forms an image.

For example, the imaging plane (IP) may be formed on one surface of an image sensor (IS) of the camera module or on a lens element disposed inside the image sensor (IS).

FIG. 8 illustrates aberration characteristics of the imaging lens system 400 according to the present embodiment. Tables 10 and 11 illustrate lens characteristics of the imaging lens system according to the present embodiment, and Table 12 illustrates lens characteristics and aspherical values of the imaging lens system according to the present embodiment.

TABLE 10

| Surface | | Curvature | Thickness/ | Refractive | | Effective |
|---|---|---|---|---|---|---|
| No. | Component | Radius | Distance | Index | Abbe No. | Radius |
| S0 | object | infinity | D0 | | | |
| S1 | 1st Lens | 55.199 | 0.4000 | 1.544 | 55.990 | 3.540 |
| S2 | | 2.8170 | 1.4700 | | | 2.650 |
| S3 | prism | infinity | 2.6000 | 1.744 | 44.900 | 3.680 |
| S4 | | infinity | 2.6000 | 1.744 | 44.900 | 4.500 |
| S5 | | infinity | 0.5400 | | | 3.680 |
| S6 | 2nd Lens | 10.5070 | 1.7000 | 1.535 | 55.740 | 2.500 |
| S7 | | −15.4260 | 2.3430 | | | 2.540 |
| S8 | stop | infinity | D1 | | | 2.550 |
| S9 | 3rd Lens | 6.0500 | 1.2650 | 1.535 | 56.000 | 2.700 |
| S10 | | −53.2250 | 0.1510 | | | 2.700 |
| S11 | 4th Lens | 7.0590 | 1.5400 | 1.535 | 55.740 | 2.700 |
| S12 | | −9.6320 | 0.3000 | | | 2.650 |
| S13 | 5th Lens | −8.0540 | 0.6000 | 1.661 | 20.380 | 2.700 |
| S14 | | 10.4150 | 1.7000 | | | 2.700 |
| S15 | 6th Lens | 17.2770 | 0.7000 | 1.650 | 21.540 | 2.600 |
| S16 | | 6.0350 | 0.2000 | | | 2.780 |
| S17 | 7th Lens | 3.9760 | 0.6610 | 1.639 | 23.490 | 2.700 |
| S18 | | 8.3180 | D2 | | | 2.950 |
| S19 | 8th Lens | 19.2370 | 1.0670 | 1.535 | 56.000 | 3.820 |
| S20 | | 124.2730 | D3 | | | 3.890 |
| S21 | Filter | infinity | 0.2100 | 1.517 | 64.200 | 3.940 |
| S22 | | infinity | D4 | | | 3.970 |
| S23 | Imaging | infinity | 0.0000 | | | |
| | Plane | | | | | |

TABLE 11

| | 1st Position | 2nd Position |
|---|---|---|
| D0 | infinity | 38.9951 |
| D1 | 1.1350 | 0.6863 |
| D2 | 1.1152 | 1.5639 |
| D3 | 0.5000 | 0.5000 |
| D4 | 0.5000 | 0.5000 |
| f | 4.0474 | 4.1039 |
| MAG | 0.0000 | 0.1000 |
| HFOV | 45.3800 | 43.0170 |
| f number | 1.6840 | 1.7810 |
| TTL | 23.2970 | 23.2970 |

TABLE 12

| Surface No. | S1 | S2 | S6 | S7 |
|---|---|---|---|---|
| K | −1.000E+00 | −1.000E+00 | −1.000E+00 | −1.000E+00 |
| A | 1.386E−03 | 3.032E−03 | −1.713E−04 | −1.459E−04 |
| B | −9.634E−04 | −4.385E−04 | 6.844E−05 | −2.934E−04 |
| C | 1.737E−04 | 4.535E−05 | −1.520E−05 | 1.176E−04 |
| D | −1.308E−05 | 3.433E−06 | 3.727E−06 | −1.721E−05 |
| E | 3.561E−07 | −3.151E−07 | −1.256E−07 | 1.065E−06 |
| Surface No. | S9 | S10 | S11 | S12 |
| K | −1.000E+00 | −1.000E+00 | −1.000E+00 | −1.000E+00 |
| A | 1.502E−03 | 7.934E−04 | 5.463E−04 | 4.128E−04 |
| B | −4.987E−04 | −1.975E−05 | −2.843E−04 | 1.182E−04 |
| C | 1.541E−04 | 5.354E−06 | 5.187E−05 | −2.200E−04 |
| D | −1.941E−05 | 3.789E−06 | 1.070E−06 | 4.299E−05 |
| E | 8.542E−07 | −4.517E−07 | −4.257E−07 | −2.439E−06 |
| Surface No. | S13 | S14 | S15 | S16 |
| K | −1.000E+00 | −1.000E+00 | −1.000E+00 | −1.000E+00 |
| A | −3.598E−03 | −6.437E−03 | −1.340E−02 | −3.249E−02 |
| B | 3.898E−03 | 4.957E−03 | 3.859E−03 | 6.999E−03 |
| C | −1.547E−03 | −1.977E−03 | −1.148E−03 | −1.725E−03 |
| D | 2.584E−04 | 3.537E−04 | 8.336E−05 | 1.878E−04 |
| E | −1.513E−05 | −2.193E−05 | 3.111E−07 | −7.345E−06 |
| Surface No. | S17 | S18 | S19 | S20 |
| K | −1.000E+00 | −1.000E+00 | −1.000E+00 | −1.000E+00 |
| A | −2.597E−02 | 3.446E−03 | 2.142E−03 | 4.829E−03 |
| B | −9.253E−04 | −9.245E−03 | −2.204E−03 | −3.255E−03 |
| C | −2.118E−06 | 2.480E−03 | 4.332E−04 | 5.600E−04 |
| D | 9.677E−05 | −2.541E−04 | −3.093E−05 | −3.696E−05 |
| E | −9.088E−06 | 9.363E−06 | 7.577E−07 | 8.354E−07 |

Table 13 illustrates characteristic values of the imaging lens system according to the embodiments of the present disclosure.

TABLE 13

| | 1^{st} | 2^{nd} | 3^{rd} | 4^{th} |
|---|---|---|---|---|
| | Embodiment | Embodiment | Embodiment | Embodiment |
| TTL | 21.041 | 21.042 | 33.4005 | 23.2971 |
| f1 | −5.7191 | −5.5427 | −8.8714 | −5.4714 |
| f2 | 15.0216 | 13.8031 | 22.9686 | 11.9587 |
| f3 | 8.6759 | 8.6772 | 15.8996 | 10.2381 |
| f4 | 5.3318 | 4.9197 | 7.4060 | 7.8693 |
| f5 | −4.4081 | −4.2374 | −6.2174 | −6.7859 |
| f6 | −41.9027 | −544.8422 | 81.2661 | −14.6199 |
| f7 | 38.7848 | — | — | 11.2488 |
| f8 | — | — | — | 42.4249 |
| Y | 3.5840 | 3.5840 | 6.1280 | 3.5840 |

According to the examples of the embodiments of the present disclosure, the imaging lens system according to the present disclosure may have unique lens characteristics. For example, a focal length of a first lens is determined within the range of −10.0 mm to −4.0 mm, a focal length of a second lens is determined within the range of 10.0 mm to 24.0 mm, and a focal length of a third lens is determined within the range of 7.0 mm to 24.0 mm. a focal length of a fourth lens is determined within the range of 4.0 mm to 9.0 mm, a focal length of a fifth lens is determined within the range of −8.0 mm to −3.0 mm, a focal length of a sixth lens may be determined at −10.0 mm or less or at 60.0 mm or more, a focal length of the seventh lens may be determined at 10.0 mm or more, and a focal length of a eighth lens may be determined at 40 mm or more.

Tables 13 to 15 illustrate conditional expression values of the imaging lens system according to the embodiments of the present disclosure.

TABLE 14

| | 1^{st} | 2^{nd} | 3^{rd} | 4^{th} |
|---|---|---|---|---|
| | Embodiment | Embodiment | Embodiment | Embodiment |
| fF/f | −1.4132 | −1.3843 | −1.3528 | −1.3459 |
| T1/SL1 | 0.3082 | 0.2794 | 0.3121 | 0.2913 |
| Dp/2Y | 1.0268 | 1.0259 | 0.8770 | 1.0259 |
| LG2R1/f | 1.3786 | 1.4051 | 1.2988 | 1.4948 |
| L1ST/STY | 0.9497 | 1.5147 | 0.7880 | 1.0008 |
| \|f/fR\| | 0.1043 | 0.0073 | 0.0807 | 0.0958 |
| EDLF/EDLR | 1.1433 | 1.1832 | 1.1260 | 0.9112 |
| fG1R/f | 3.7118 | 3.4475 | 3.5025 | 2.9422 |

TABLE 15

| | 1^{st} | 2^{nd} | 3^{rd} | 4^{th} |
|---|---|---|---|---|
| | Embodiment | Embodiment | Embodiment | Embodiment |
| D12/f | 1.7717 | 1.7908 | 1.5554 | 1.781391 |
| R1/R2 | 9.5206 | 12.0766 | 8.2482 | 19.59496 |
| (R1 + R4)/(R2 + R3) | 0.0786 | −2.5111 | −2.4555 | 2.98506 |
| R5/R7 | 1.3758 | 1.3263 | 1.0638 | 0.85706 |
| (R3 + R12)/R8 | −4.6014 | −5.9626 | −4.2677 | −1.71740 |
| (R3 + R12)/(R8 + R9) | −2.3007 | −2.9813 | −2.1339 | −0.93532 |

TABLE 16

| | 1^{st} | 2^{nd} | 3^{rd} | 4^{th} |
|---|---|---|---|---|
| | Embodiment | Embodiment | Embodiment | Embodiment |
| f1/f2 | −0.3807 | −0.4016 | −0.3862 | −0.45753 |
| (f1 + f2)/f3 | 1.0722 | 0.9520 | 0.8866 | 0.63364 |
| (f1 + f5)/f3 | −1.1673 | −1.1271 | −0.9490 | −1.19722 |
| f1/f5 | 1.2974 | 1.3080 | 1.4269 | 0.80629 |
| (f3 + f4)/f2 | 0.9325 | 0.9851 | 1.0147 | 1.51417 |
| (f3 − f4)/f5 | −0.7586 | −0.8867 | −1.3661 | −0.34907 |
| (f3 + f5)/f4 | 0.8004 | 0.9024 | 1.3073 | 0.43869 |
| (f1 + f2)/R5 | 1.6674 | 1.4683 | 1.6552 | 1.07228 |
| (f2 + R12)/(f3 + R12) | 1.2418 | 1.1757 | 1.2653 | 1.10573 |

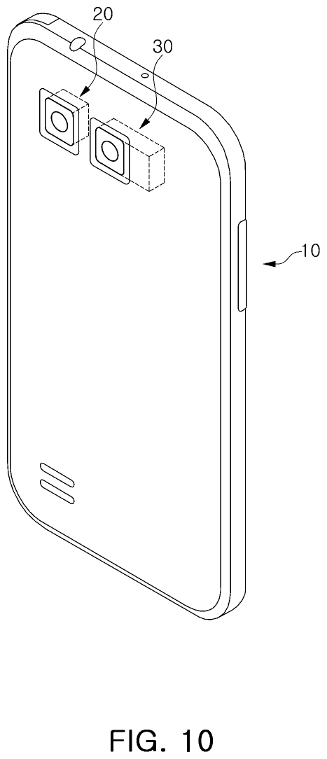

An electronic device according to an embodiment will be described with reference to FIG. 10.

An electronic device 10, according to an embodiment of the present disclosure, may include a camera module. As an example, the electronic device 10 may be a portable terminal that includes camera modules 20 and 30. However, the form of the electronic device 10 is not limited to being a portable terminal. As an example, the electronic device 10 may include any portable electronic device, such as a laptop or tablet PC. The electronic device 10, according to an embodiment may include one or more of the imaging lens systems 100, 200, and 300 according to the embodiments of the present disclosure. As an example, at least one of the first camera module 20 and the second camera module 30 installed on one side of the electronic device 10 may be an imaging lens system 100, 200, and 300 according to the first to third embodiments.

The present disclosure may significantly reduce resolution degradation caused by changes in the position of a lens or lens group.

In addition, the present disclosure may capture images of objects at infinite distances and near objects at a constant resolution.

While specific examples have been shown and described above, it will be apparent after an understanding of this disclosure that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. An imaging lens system comprising:
a first lens group comprising one or more lenses; and
a second lens group, comprising one or more lenses, configured to be movable in an optical axis direction,
wherein the first lens group and the second lens group are arranged sequentially from an object side, and
wherein the imaging lens system satisfies 2.80≤fG1R/f≤4.0,
where f is a focal length of the imaging lens system, and fG1R is a focal length of a first rear lens disposed closest to an imaging plane in the first lens group.

2. The imaging lens system of claim 1, wherein the first rear lens has a convex image-side surface.

3. The imaging lens system of claim 1, wherein the first lens group has a total of two lenses.

4. The imaging lens system of claim 1, wherein the second lens group has a total of four or five lenses.

5. The imaging lens system of claim 1, wherein a rearmost lens disposed closest to the imaging plane has positive refractive power.

6. The imaging lens system of claim 1, wherein a foremost lens disposed closest to an object has negative refractive power.

7. The imaging lens system of claim 1, satisfying
$$- 1.5 < fF / f < - 1.2 ,$$
where fF is a focal length of a foremost lens disposed closest to the object.

8. An imaging lens system comprising:
a first lens, an optical path converter, a second lens, a third lens, a fourth lens, a fifth lens, and a sixth lens, sequentially arranged from an object side,
wherein the imaging lens system satisfies
$$2.8 \leq f 2 / f \leq 4. , and$$
$$1.4 < D 12 / f < 2.2 ,$$
where f is a focal length of the imaging lens system, f2 is a focal length of the second lens, and D12 is a distance from an image-side surface of the first lens to an object-side surface of the second lens.

9. The imaging lens system of claim 8, wherein the first lens has a convex object-side surface.

10. The imaging lens system of claim 8, wherein the second lens has a convex object-side surface.

11. The imaging lens system of claim 8, wherein the third lens has a convex object-side surface.

12. The imaging lens system of claim 8, wherein the fourth lens has a convex object-side surface.

13. The imaging lens system of claim 8, wherein the fifth lens has a concave object-side surface.

14. The imaging lens system of claim 8, wherein the sixth lens has a convex object-side surface.

15. The imaging lens system of claim 8, wherein the imaging lens system further comprises a seventh lens disposed on an image side of the sixth lens.

16. The imaging lens system of claim 15, wherein the seventh lens has a convex object-side surface.

17. An imaging lens system comprising:
a first lens group comprising one or more lenses; and
a second lens group, comprising one or more lenses, configured to be movable in an optical axis direction,
wherein the first lens group and the second lens group are arranged sequentially from an object side, and
wherein the imaging lens system satisfies −1.5<f1/f<−1.20 and 2.80≤f2/f≤4.0,
where f is a focal length of the imaging lens system, f1 is a focal length of a first lens of the imaging lens system, and f2 is a focal length of a second lens of the imaging lens system.

18. The imaging lens system of claim 17, wherein a first rear lens disposed closest to an imaging plane in the first lens group has a convex image-side surface.

19. The imaging lens system of claim 17, wherein the first lens group has a total of two lenses.

20. The imaging lens system of claim 17, wherein the second lens group has a total of four or five lenses, and
wherein a rearmost lens disposed closest to an imaging plane in the first lens group has positive refractive power.
